(19) United States
(12) Patent Application Publication
(10) Pub. No.: US 2013/0088805 A1
(43) Pub. Date: Apr. 11, 2013

(54) OVERHEATING PROTECTION CIRCUIT FOR ELECTRONIC DEVICES

(71) Applicants: YING-BIN FU, Shenzhen City (CN); TING GE, Shenzhen City (CN); YA-JUN PAN, Shenzhen City (CN)

(72) Inventors: YING-BIN FU, Shenzhen City (CN); TING GE, Shenzhen City (CN); YA-JUN PAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/528,841

(22) Filed: Jun. 21, 2012

(30) Foreign Application Priority Data
Oct. 10, 2011 (CN) 201110304240.7

(51) Int. Cl. H02H 5/04

(52) U.S. Cl. 361/106; 361/103

(57) ABSTRACT

An overheating protection circuit for an electronic device includes a detection circuit, a switch element, and a control element. The detection circuit is positioned adjacent to an integrated circuit (IC) peripheral circuit of the electronic device and detects a temperature of the IC peripheral circuit. The switch element is electrically connected to the detection circuit, and the control element is electrically connected to the switch element and a heat dissipation device of the electronic device. The detection circuit generates a detection signal to turn on the switch element in response to detecting that a temperature of the IC peripheral circuit increases, and the control element controls the heat dissipation device to dissipate heat generated by the IC peripheral circuit in response to detecting that the switch element is turned on.

### BACKGROUND

1. Technical Field

The present disclosure relates to overheating protection circuits for electronic devices, and particularly to an overheating protection circuit for peripheral circuits of integrated circuits (ICs).

2. Description of Related Art

ICs are usually electrically connected to various peripheral electronic components, such as power supplies, resistors, capacitors, and transistors. In use of the ICs, the peripheral electronic components may generate much heat. Although the ICs generally include overheating protection circuits, most common overheating protection circuits can only prevent the ICs themselves from overheating, and may be difficult to prevent the peripheral electronic components from overheating.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a circuit diagram of an overheating protection circuit, according to a first exemplary embodiment.

FIG. 2 is a circuit diagram of an overheating protection circuit, according to a second exemplary embodiment.

### DETAILED DESCRIPTION

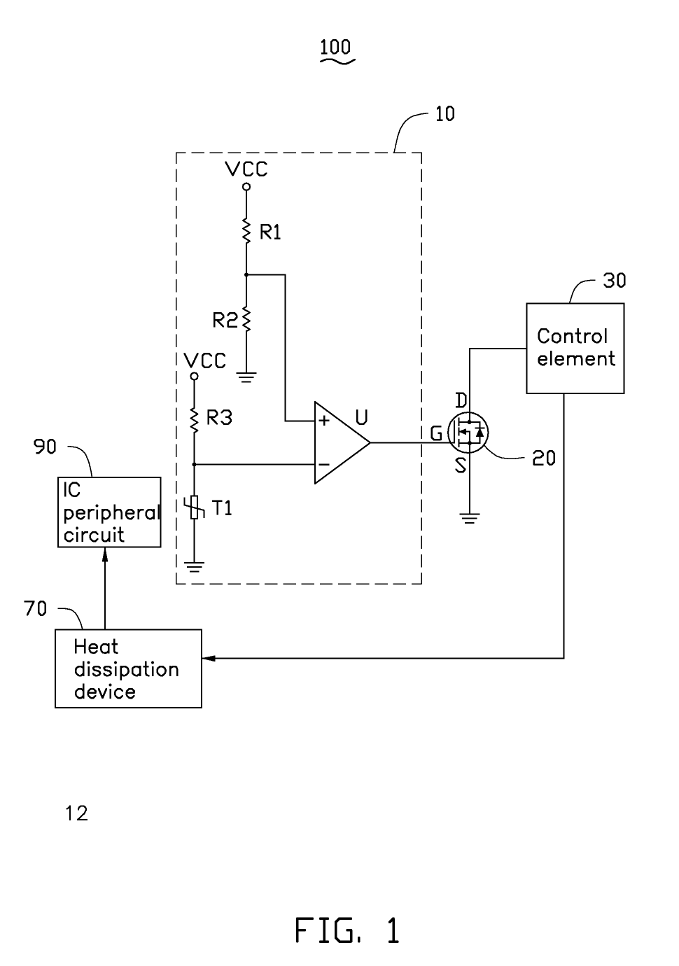

FIG. 1 is a circuit diagram of an overheating protection circuit 100, according to a first exemplary embodiment. The overheating protection circuit 100 can be used in an electronic device, for example, a personal computer (PC), to prevent IC peripheral circuits of the electronic device from overheating. In this embodiment, the overheating protection circuit 100 cooperates with a common heat dissipation device 90, for example, a fan, to protect an IC peripheral circuit 90 of the electronic device from overheating. The IC peripheral circuit 90 includes peripheral electronic components electrically connected to ICs of the electronic device, such as power supplies, resistors, capacitors, and transistors, for example. The heat dissipation device 70 is mounted at a predetermined position and is adapted to dissipate heat generated by the IC peripheral circuit 90.

The overheating protection circuit 100 includes a detection circuit 10, a switch element 20, and a control element 30. The detection circuit 10 is positioned adjacent to the IC peripheral circuit 90, detects a temperature of the IC peripheral circuit 90, and is electrically connected to the control element 30 via the switch element 20.

The detection circuit 10 includes a comparator U, three resistors R1, R2, R3, a power supply Vcc, and a thermistor T1. The comparator U can be an operational amplifier, which includes a positive input pin, a negative input pin, and an output pin. The resistors R1 and R2 are electrically connected in series between the power supply Vcc and a ground. The positive input pin of the comparator U is electrically connected between the resistors R1 and R2. The resistor R3 and the thermistor T1 are electrically connected in series between the power supply Vcc and a ground. In this embodiment, the resistor R3 is electrically connected between the power supply Vcc and the thermistor T1, and the thermistor T1 is a negative temperature coefficient (NTC) thermistor electrically connected between the resistor R3 and the ground. The negative input pin of the comparator U is electrically connected between the resistor R3 and the thermistor T1.

The switch element 20 is a metal-oxide-semiconductor field-effect transistor (MOSFET), which includes a gate G, a drain D, and a source S. The gate G is electrically connected to the output pin of the comparator U to receive detection signals from the comparator U. The drain D is electrically connected to the control element 30. The source S is grounded.

The control element 30 can be a baseboard management controller (BMC) or a pulse width modulation (PWM) microchip. The control element 30 is also electrically connected to the heat dissipation device 70 to control the heat dissipation device 70.

In use, the power supply Vcc is turned on, and provides a predetermined voltage. The predetermined voltage is applied on the resistors R1, R2, R3 and the thermistor T1, and thereby forms a first input voltage input to the positive input pin and a second input voltage input to the negative input pin. A value of the first input voltage is determined according to resistances of the resistors R1 and R2, and is a constant. Similarly, a value of second input voltages is determined according to resistances of the resistor R3 and the thermistor T1, and changes in response to resistance changes of the thermistor T1.

In this embodiment, when the IC peripheral circuit 90 is in an off status, the resistances of the resistors R1, R2, R3 and the thermistor T1 are predetermined to ensure that the first input voltage is lower than the second input voltage. Thus, the comparator U outputs a first detection signal (e.g., a relatively lower output voltage) to the gate G of the switch element 20, and the switch element 20 stays off. The control element 30 detects that the drain D of the switch element 20 is suspended, and does not turns on the heat dissipation device 70 in response to detecting the suspended drain D.

The thermistor T1 detects a temperature of the IC peripheral circuit 90. The thermistor T1 is an NTC thermistor, thus, the resistance of the thermistor T1 decreases if a temperature of the thermistor T1 increases. In addition, the resistance of the termister T1 increases when the temperature of the thermistor T1 decreases. The temperatures of the IC peripheral circuit 90 and the thermistor T1 increase, and the resistance of thermistor T1 decreases if the IC peripheral circuit 90 generates heat while working. Correspondingly, the second input voltage decreases. Once the second input voltage becomes lower than the first input voltage, the comparator U outputs a second detection signal (e.g., a relatively higher output voltage) to the gate G of the switch element 20. Thus, the switch element 20 is turned on. The control element 30 detects if the drain D of the switch element 20 is grounded, and turns on the heat dissipation device 70 in response to detecting the grounded drain D. Thus, the heat dissipation device 70 dissipates heat generated by the IC peripheral circuit 90.

When the IC peripheral circuit 90 cools down, the temperature of the thermistor T1 decreases, and the resistance of thermistor T1 increases. Correspondingly, the second input voltage increases. Once the second input voltage becomes higher than the first input voltage, the comparator U outputs the relatively lower output voltage to the gate G of the switch element 20, and the switch element 20 is turned off. In response to detecting that the drain D is suspended, the control element 30 turns off the heat dissipation device 70.

The control element 30 can also be electrically connected to the IC peripheral circuit 90. In use, during a predetermined detection time, the control element 30 can continuously enhance working power of the heat dissipation device 70 to cool down the IC peripheral circuit 90 as soon as possible. When the predetermined detection time has elapsed, if the control element 30 does not detect that the drain D is suspended, the control element 30 determines that the IC peripheral circuit 90 is too hot to work normally, and controls the IC peripheral circuit 90 to be turned off.

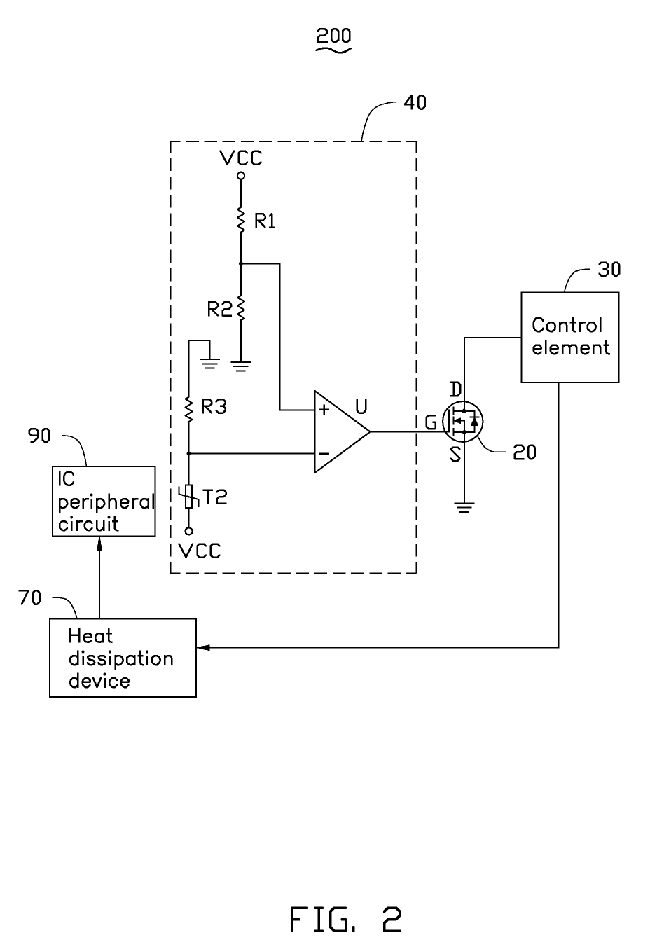

FIG. 2 is a circuit diagram of an overheating protection circuit 200, according to a second exemplary embodiment. The overheating protection circuit 200 differs from the overheating protection circuit 100 in that another detection circuit 40 replaces the detection circuit 10. The detection circuit 40 differs from the detection circuit 10 in that the thermistor T1 is replaced by a positive temperature coefficient (PTC) thermistor T2, and the thermistor T2 and the resistor R3 are electrically connected in series between the power supply Vcc and a ground. In particular, the thermistor T2 is electrically connected between the power supply Vcc and the resistor R3, and the resistor R3 is electrically connected between the thermistor T2 and the ground. The negative input pin of the comparator U is electrically connected between the thermistor T2 and the resistor R3.

The thermistor T2 is used to detect the temperature of the IC peripheral circuit 90. The thermistor T2 is a PTC thermistor, thus the resistance of the thermistor T2 increases when a temperature of the thermistor T2 increases, and decreases when the temperature of the thermistor T2 decreases. Temperatures of the IC peripheral circuit 90 and the thermistor T2 increase, and the resistance of thermistor T2 increases, when the IC peripheral circuit 90 generates heat during working. Correspondingly, the second input voltage decreases. Once the second input voltage becomes lower than the first input voltage, the switch element 20 is turned on, and the control element 30 turns on the heat dissipation device 70 according to the aforementioned method. When the IC peripheral circuit 90 is cooled down, the temperature of the thermistor T2 decreases, and the resistance of thermistor T2 decreases. Correspondingly, the second input voltage increases. Once the second input voltage becomes higher than the first input voltage, the switch element 20 is turned off, and the control element 30 turns off the heat dissipation device 70 according to the aforementioned method.

The overheating protection circuits (e.g., 100, 200) provided by the present disclosure can control the heat dissipation device 70 to cool down the IC peripheral circuit 90, thereby protecting the IC peripheral circuit 90 from overheating. Additionally, the present disclosure can also be used to protect ICs from overheating, as typical overheating protection devices.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An overheating protection circuit for an electronic device, comprising:
a detection circuit positioned adjacent to an integrated circuit (IC) peripheral circuit of the electronic device and configured for detecting a temperature of the IC peripheral circuit;
a switch element electrically connected to the detection circuit; and
a control element electrically connected to the switch element and a heat dissipation device of the electronic device;
wherein the detection circuit generates detection signals to turn on the switch element in response to detecting that a temperature of the IC peripheral circuit increases, and the control element controls the heat dissipation device to dissipate heat generated by the IC peripheral circuit in response to detecting that the switch element is turned on.

2. The overheat protection circuit as claimed in claim 1, wherein the detection circuit further includes a thermistor configured to detect the temperature of the IC peripheral circuit.

3. The overheating protection circuit as claimed in claim 2, wherein the detection circuit includes a comparator, and the comparator includes a positive input pin, a negative input pin, and an output pin; the positive input pin receives a constant first input voltage, the negative input pin receives a second input voltage determined according to the temperature of the IC peripheral circuit, and the output pin is electrically connected to the switch element; the comparator outputs a first detection signal to the switch element to turn on the switch element when the first input voltage is higher than the second input voltage, and outputs a second detection signal to the switch element to turn off the switch element when the first input voltage is lower than the second input voltage.

4. The overheating protection circuit as claimed in claim 3, wherein the detection circuit further includes a power supply and a plurality of resistors; a first resistor and a second resistor of the plurality of resistors are electrically connected in series between the power supply and a ground, the positive input pin is electrically connected between the first and second resistors, and a voltage between the first and second resistors is input to the positive input pin as the first input voltage.

5. The overheating protection circuit as claimed in claim 4, wherein a third resistor of the plurality of resistors and the thermistor are electrically connected in series between the power supply and a ground, the negative input pin is electrically connected between the third resistor and the thermistor, and a voltage between the third resistor and the thermistor is input to the negative input pin as the second input voltage.

6. The overheating protection circuit as claimed in claim 5, wherein the thermistor is a negative temperature coefficient (NTC) thermistor, the third resistor is electrically connected between the power supply and the thermistor, and the thermistor is electrically connected between the third resistor and a ground.

7. The overheating protection circuit as claimed in claim 5, wherein thermistor is a positive temperature coefficient (PTC) thermistor, the thermistor is electrically connected between the power supply and the third resistor, and the third resistor is electrically connected between the thermistor and a ground.

8. The overheating protection circuit as claimed in claim 5, wherein the switch element is a metal-oxide-semiconductor field-effect transistor (MOSFET) and includes a gate, a drain, and a source; the gate is electrically connected to the output pin of the comparator to receive the first and second detection signals from the comparator, the drain is electrically connected to the control element, and the source is grounded.

9. The overheating protection circuit as claimed in claim 8, wherein the control element turns on the heat dissipation device in response to detecting that the drain is grounded, and turns off the heat dissipation device in response to detecting that the drain is suspended.

10. The overheating protection circuit as claimed in claim 1, wherein the control element is electrically connected to the IC peripheral circuit and controls the IC peripheral circuit to be turned on and off.

11. An electronic device, comprising:
an integrated circuit (IC) peripheral circuit;
a heat dissipation device; and
an overheating protection circuit, comprising:
a detection circuit positioned adjacent to the IC peripheral circuit and configured for detecting a temperature of the IC peripheral circuit;
a switch element electrically connected to the detection circuit; and
a control element electrically connected to the switch element and the heat dissipation device;
wherein the detection circuit generates detection signals to turn on the switch element in response to detecting that a temperature of the IC peripheral circuit increases, and the control element controls the heat dissipation device to dissipate heat generated by the IC peripheral circuit in response to detecting that the switch element is turned on.

12. The electronic device as claimed in claim 11, wherein the detection circuit further includes a thermistor configured to detect the temperature of the IC peripheral circuit.

13. The electronic device as claimed in claim 12, wherein the detection circuit includes a comparator, and the comparator includes a positive input pin, a negative input pin, and an output pin; the positive input pin receives a constant first input voltage, the negative input pin receives a second input voltage determined according to the temperature of the IC peripheral circuit, and the output pin is electrically connected to the switch element; the comparator outputs a first detection signal to the switch element to turn on the switch element when the first input voltage is higher than the second input voltage, and outputs a second detection signal to the switch element to turn off the switch element when the first input voltage is lower than the second input voltage.

14. The electronic device as claimed in claim 13, wherein the detection circuit further includes a power supply and a plurality of resistors; a first resistor and a second resistor of the plurality of resistors are electrically connected in series between the power supply and a ground, the positive input pin is electrically connected between the first and second resistors, and a voltage between the first and second resistors is input to the positive input pin as the first input voltage.

15. The electronic device as claimed in claim 14, wherein a third resistor of the plurality of resistors and the thermistor are electrically connected in series between the power supply and a ground, the negative input pin is electrically connected between the third resistor and the thermistor, and a voltage between the third resistor and the thermistor is input to the negative input pin as the second input voltage.

16. The electronic device as claimed in claim 15, wherein the thermistor is a negative temperature coefficient (NTC) thermistor, the third resistor is electrically connected between the power supply and the thermistor, and the thermistor is electrically connected between the third resistor and a ground.

17. The electronic device as claimed in claim 15, wherein thermistor is a positive temperature coefficient (PTC) thermistor, the thermistor is electrically connected between the power supply and the third resistor, and the third resistor is electrically connected between the thermistor and a ground.

18. The electronic device as claimed in claim 15, wherein the switch element is a metal-oxide-semiconductor field-effect transistor (MOSFET) and includes a gate, a drain, and a source; the gate is electrically connected to the output pin of the comparator to receive the first and second detection signals from the comparator, the drain is electrically connected to the control element, and the source is grounded.

19. The electronic device as claimed in claim 18, wherein the control element turns on the heat dissipation device in response to detecting that the drain is grounded, and turns off the heat dissipation device in response to detecting that the drain is suspended.

20. The electronic device as claimed in claim 11, wherein the control element is electrically connected to the IC peripheral circuit and controls the IC peripheral circuit to be turned on and off.
